(19) United States
(12) Patent Application Publication
(10) Pub. No.: US 2014/0083304 A1
(43) Pub. Date: Mar. 27, 2014

(54) PUREE VEGETABLE SOUP MAKER

(71) Applicant: ZHIPENG HE, Guangzhou (CN)

(72) Inventor: ZHIPENG HE, Guangzhou (CN)

(21) Appl. No.: 13/629,319

(22) Filed: Sep. 27, 2012

(51) Int. Cl. A47J 27/00

(52) U.S. Cl. CPC A47J 27/002
USPC 99/348

(57) ABSTRACT

An all in one vegetable soup maker comprises two separated units, Body and Functional unit which is detachable and has heating element and blender mechanism. The soup maker body can accommodate a soup bowl and has a spring loaded gasket feature. The gasket can be pushed down by the Functional unit to seal off the soup bowl mouth during cooking and return to position as Functional unit lifts up. This new design surpasses conventional thinking that separates the soup bowl from the machine itself which enables the soup bowl to be used as a utensil, makes easier to add spices and to clean. Further, this new design adopts a unique seal-off feature that prevents spills from soup cooking.

### BRIEF DESCRIPTIONS OF DRAWING

FIG. 1, soup maker body assembly (1)

FIG. 2, soup maker body (1) holding soup bowl (3)

FIG. 3, functional top unit (2) to engage soup maker body (1)

FIG. 4, complete assembly of Soup Maker

FIG. 5, functional top unit structure

FIG. 6, functional top unit (2) engages to soup maker body (1)

FIG. 7, explosion drawing of FIG. 6, basket unengaged

FIG. 8, explosion drawing of FIG. 4, basket engaged

FIG. 9, reference

Assembly Illustration I, soup maker body, soup bowl and functional top unit completes whole soup maker

Assembly Illustration II, functional top unit, soup maker body and soup bowl put together to cook

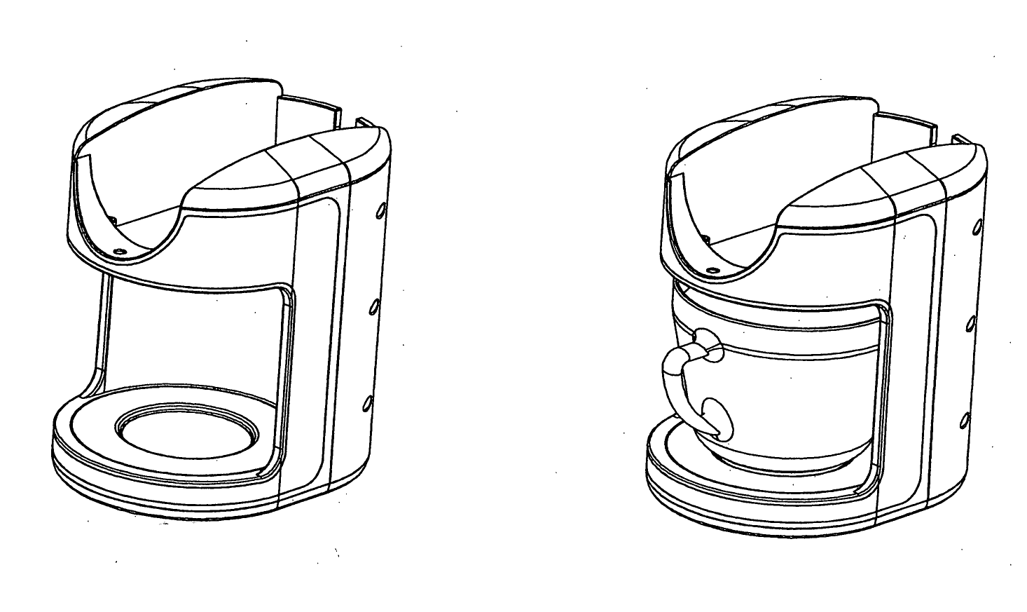

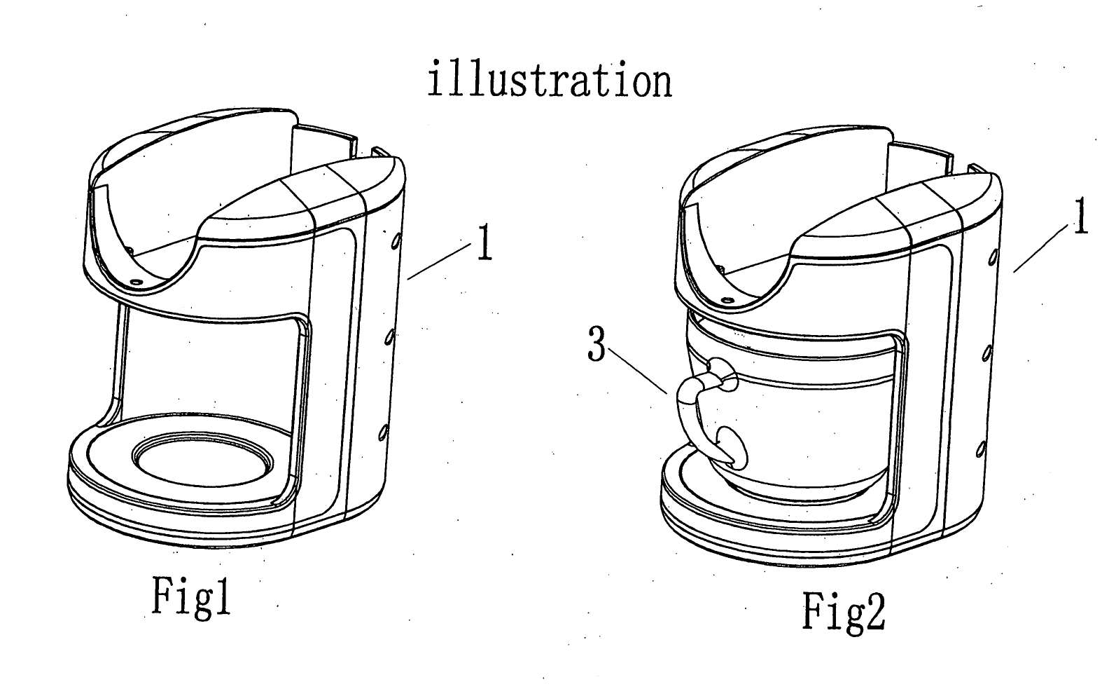

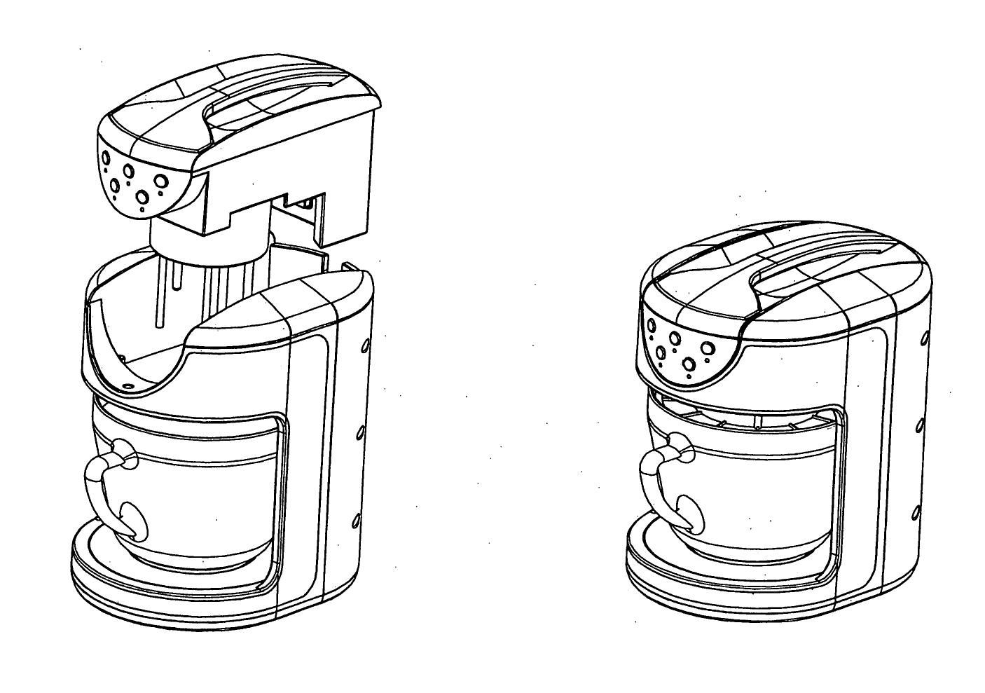

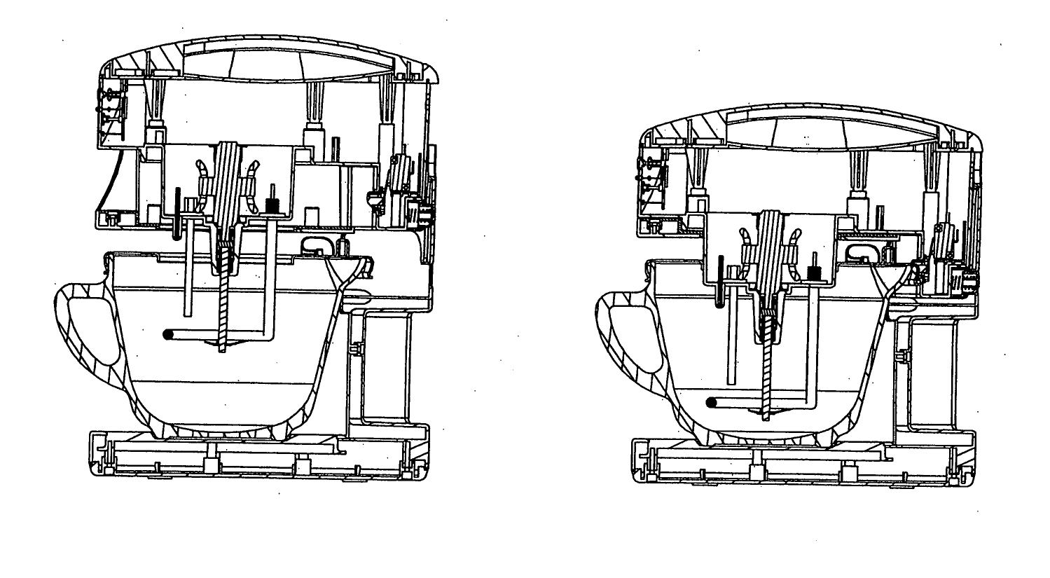

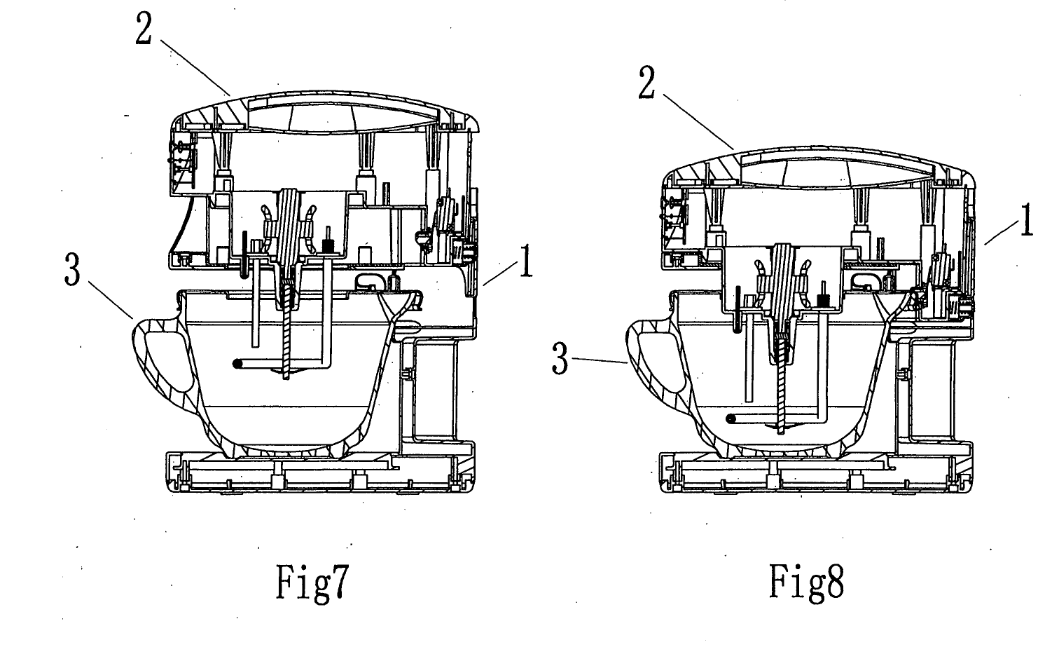

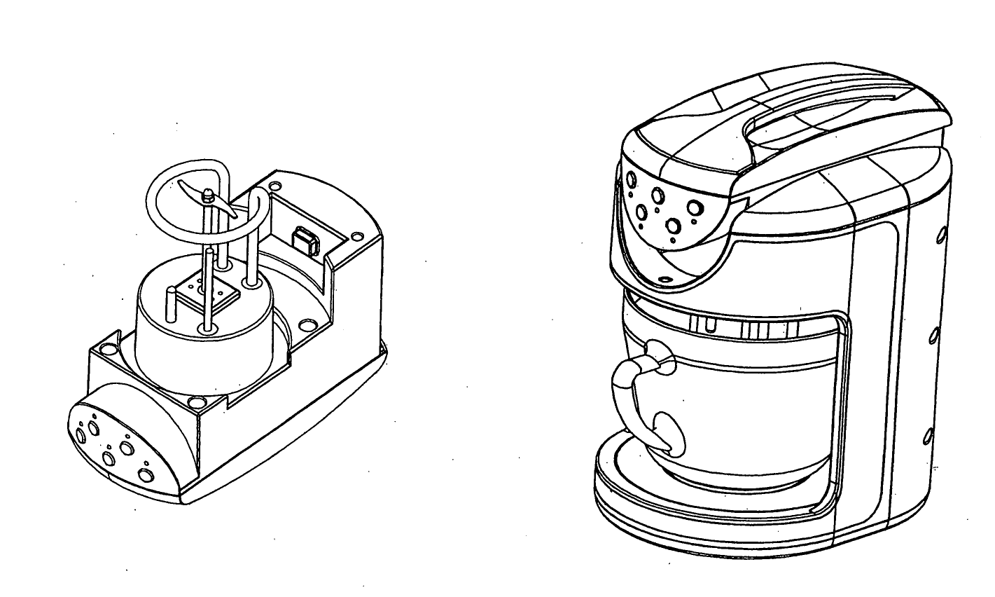

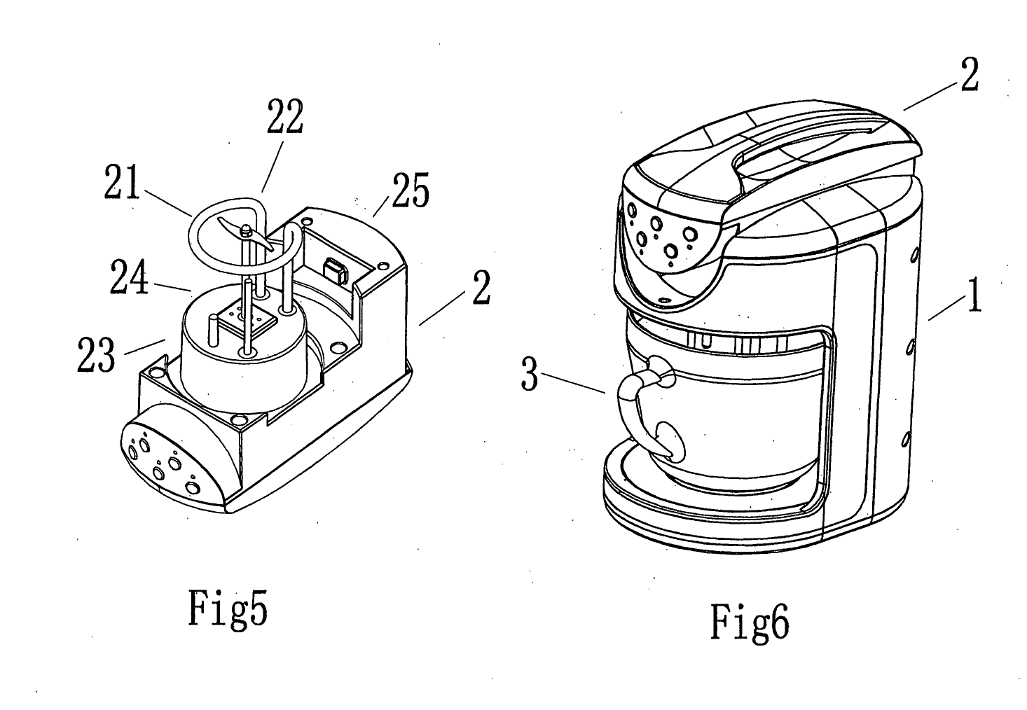

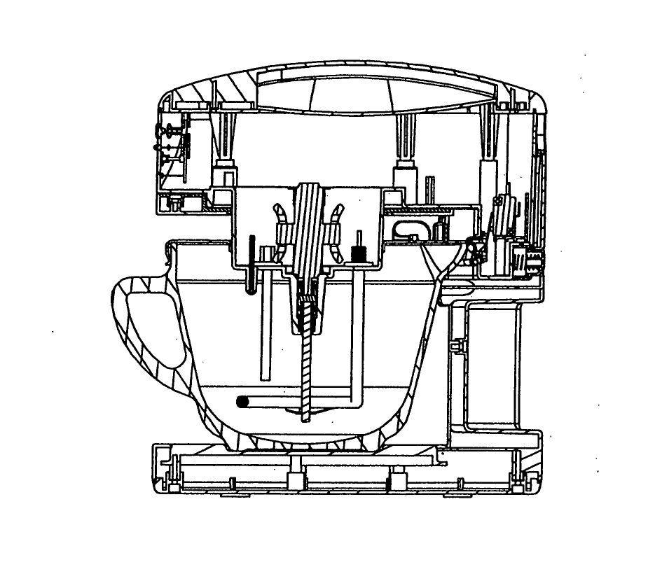

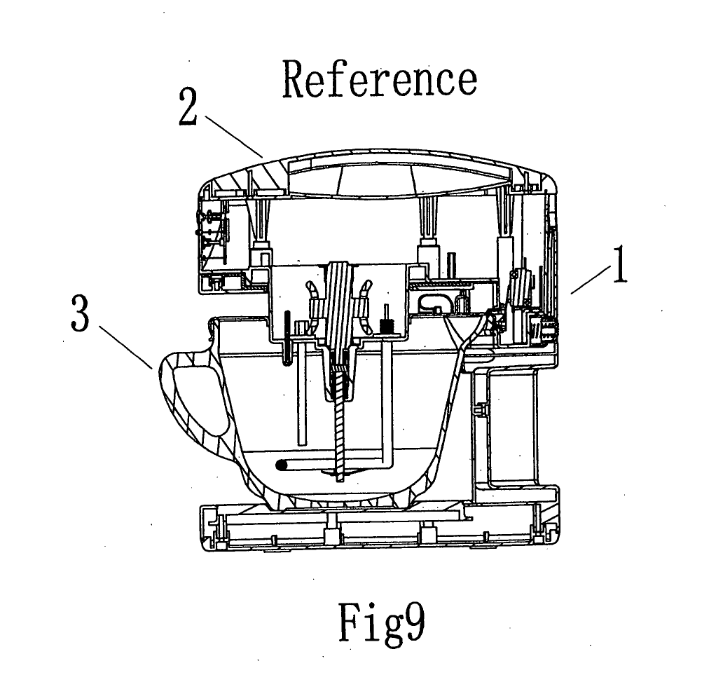

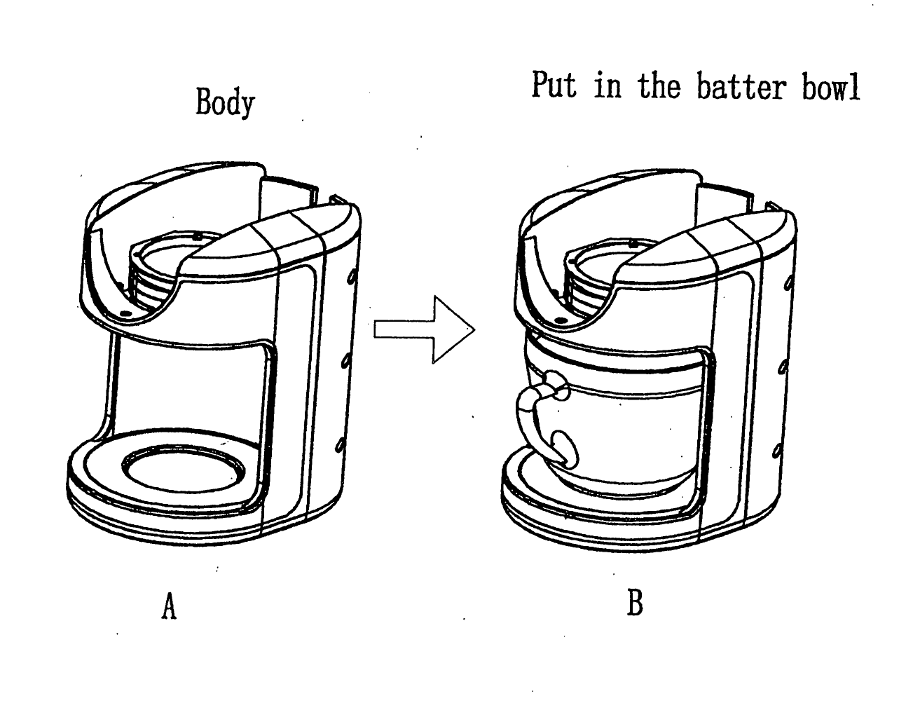

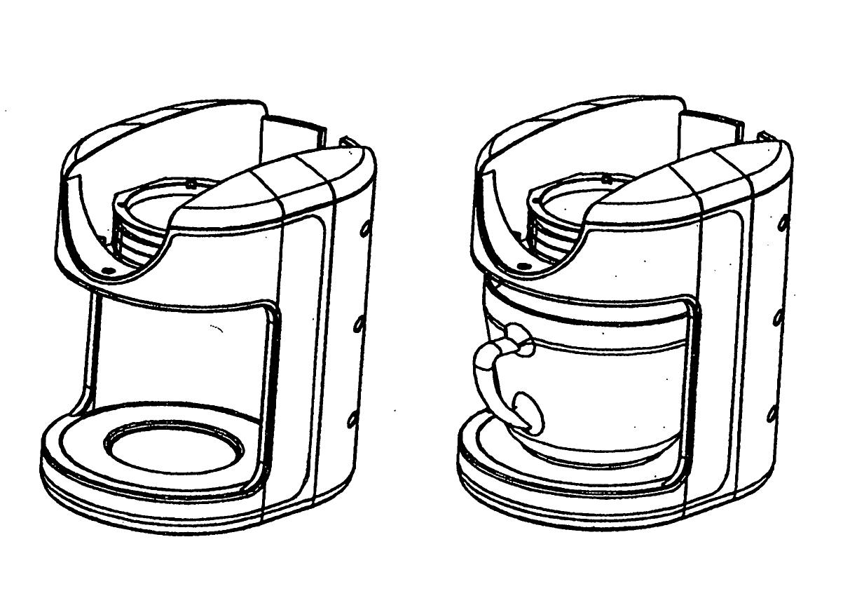

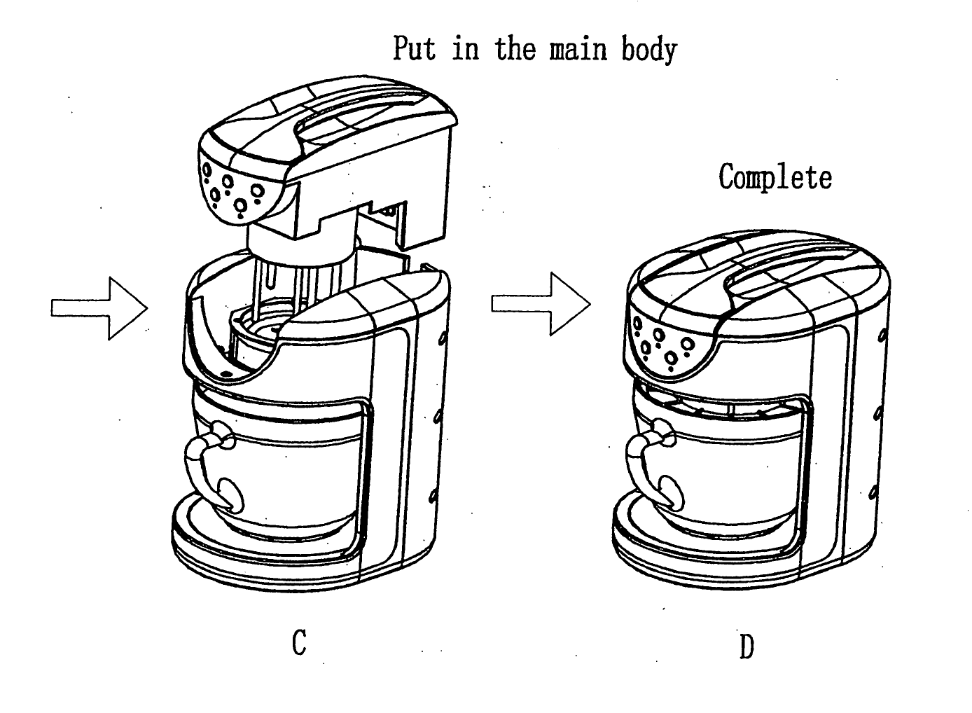

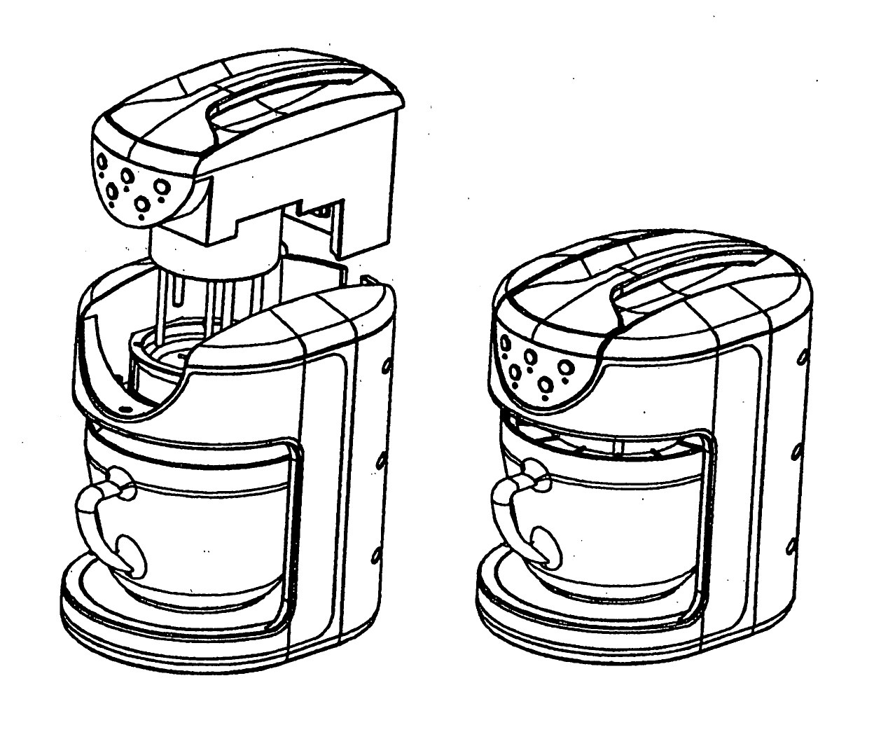

In FIG. 1-FIG. 9:

| | |
|---|---|
| 1, soup maker body | 11, gasket |
| 2, functional top unit | 12, gasket spring mechanism |
| 3, soup bowl | 21, heating element |
| 22, blender mechanism | 23, electronic over-float sensor |
| 24, electronic temperature/liquid level | 25, safety cut-off switch |
| sensor | |

### TECHNOLOGY BACK GROUND OF INVENTION

New technology involved in a soup maker offers users easier way of cooking soups. Soup makers on the market generally comprise a pitcher removable from soup maker which has both blender and heating functions on the bottom or only heating element on the top unit. When cooking, users put food ingredients in the pitch and then insert it to the unit to blend and cook. After cooking, users need to remove the pitcher, usually a large one, to wash which is not very convenient. Beside the pitcher can be used to serve soup like a soup bowl.

Invention Details:

In order to improve other soup makers inconvenience areas, our soup maker delivers innovative and technical points as follow:

A soup maker comprises separately, a body and a functional top unit. The functional top unit has a heating element and a blender mechanism. The body lower part can house a removable soup bowl. The upper part has a spring loaded gasket to engage the mouth of soup bowl. This spring loaded gasket is pushed down by the weight of the functional top unit to seal off the mouth of soup bowl. By lifting functional top unit, gasket releases itself from the soup bowl.

Further, functional top unit comprises an electronic over-float sensor

Further, functional top unit comprises an electronic temperature/liquid level sensor

Further, functional top unit comprises a safety power cut-off switch activated by the lip of soup bowl

Further, functional top unit comprises a heating element

Further, functional top unit comprises a blender blade and complete blending mechanism

Compared to current technology of other soup makers, our invention goes beyond conventional concepts of taking the soup bowl (pitcher on other soup makers) independent from the soup maker, it can not only serve as part of soup maker but also as a utensil to hold foods. It makes easier to adding spices as well as to clean. Further, our invention offers the unique spring loaded gasket that prevents over spills during cooking.

### OPERATION ILLUSTRATION

In order to adequately support the invention unique features of this soup maker, we hereby use FIG. 1-8 to demonstrate its concept, construction and intended results.

In FIG. 1-8, we publicize a soup maker that comprises a body(1), a functional top unit(2), and a soup bowl(3). Functional top unit (2) engages from above to the body (1) which can hold the soup bowl (3).

In FIG. 5, the functional top unit comprises heating element (21), blender blade (22), electronic over-float sensor (23), electronic temperature/liquid level sensor (24) and safety switch activated with soup bowl lip, all of which are controlled by electronic components installed inside the unit that delivers heating power, blending, over-float prevention, temperature and liquid level control. As for the heating element, heat tube (21) shown here, it can also be other heating elements like heating plate and light bulb to deliver heat. As for the blender blade (22), the design is not limited to a blade; it can also be a shaft.

In FIG. 7-8, in order to achieve leak proof during booking, the body (1) comprises a gasket (11) to cover the soup bowl and a spring loading mechanism (12). The spring loaded gasket (11) is pushed down by the weight of functional top unit to engage the mouth of soup bowl (3) and releasing engagement is done by lifting the functional top unit from the body.

In FIG. 1-4, to use the soup maker, first insert the soup bowl into the soup maker body and then drop the functional top unit from above. In FIG. 7-8, spring loaded gasket engages mouth of the bowl by the weight of the functional top unit. By lifting the functional top unit, gasket disengage itself from the soup bowl. We chose this soup bowl as independent vessel from the soup maker so that the soup bowl can not only hold foods as a utensil but also offers access to adding spices and easy cleaning. Further, our invention also offers unique spill prevention achieved by spring loaded gasket.

According to disclosure of detail illustrations of technical and operational explanation, we conclude that engineers of our industry need no inventive inputs to make improvements and changes to our invention concepts, therefore, we reserve our rights to defend our invention against anyone in our industry who uses our conceptual ideas, technical designs as well as utility of our product to perform reverse engineering to achieve same result.

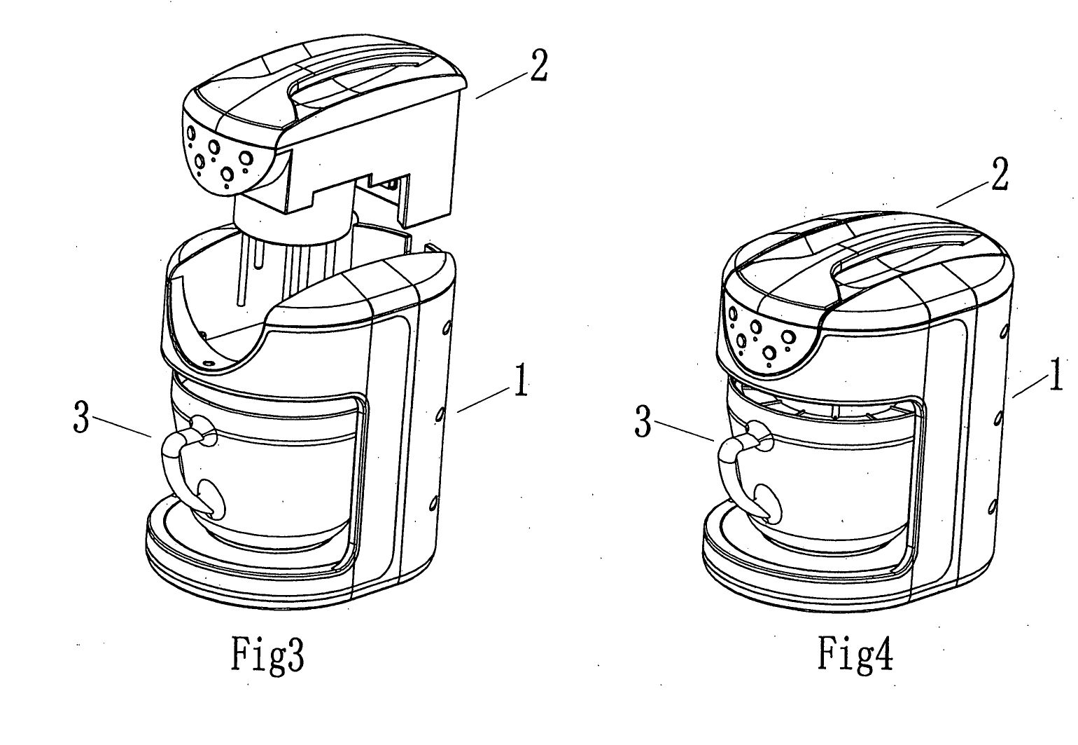

1, A soup maker comprises two separated units, Body (FIG. 1) and Functional unit (FIG. 3) that goes into the Body. The Functional
unit comprises heating element and a blender. The Body can accommodate a soup bowl (FIG. 5, 21/22)
There is a basket installed in upper side of the Body (FIG. 7, 11) down by the Functional unit (FIG. 8, 2) to seal off soup
bowl mouth (FIG. 8, 11-12) The spring loaded gasket releases from soup bowl mouth when the Functional unit is lifted.

2, Based on claim 1, the soup maker has further special equipments:
On the Functional unit, (FIG. 3, 23) has a liquid over float electronic sensor

3, Based on claim 1, the soup maker has further special equipments:
The Functional unit has (FIG. 5, 24) a temperature/liquid level electronic sensor

4, Based on claim 1, the soup maker has further special equipments:
The functional unit has a safety switch (FIG. 5, 25) activated by the lip of soup bowl

5, Based on claim 1, the soup maker has further special equipments:
The Functional unit has a heating element (FIG. 5, 21)

6, Based on claim 1, the soup maker has further special equipments:
The functional unit has a blade, part of blender assembly Further support to our claims of heating element and blade as part of blender assembly;
In comparison to other soup makers, our invention goes beyond conventional thinking that is to have a food holding vessel independent from the soup maker. This vessel (soup bowl) not only holds soup and but also allows easy access to adding spices and to cleaning.
